(19) United States
(12) Patent Application Publication
(10) Pub. No.: US 2007/0070648 A1
(43) Pub. Date: Mar. 29, 2007

(54) Light guide panel for a back light unit, and method of manufacturing the light guide panel

(75) Inventor: Sung-chul Kim, Changwon-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 11/355,344

(22) Filed: Feb. 15, 2006

(30) Foreign Application Priority Data
Sep. 28, 2005 (KR) 10-2005-0090758

(51) Int. Cl. F21V 7/04

(52) U.S. Cl. 362/600

(57) ABSTRACT

Provided are a light guide panel, a back light unit including the light guide panel, and a method of manufacturing the light guide panel. The light guide panel includes: a light guide panel body including an incidence surface receiving light irradiated from a back light source and an emission surface emitting the received light; and a polarizing coating layer positioned above the emission surface and including at least one coating layer coated with an inorganic compound having a refractive index of at least 2.0. Here, a difference between transmittances of P and S wave of polarized light having passed through the polarizing coating layer from the light guide panel body is at least 50% in a visible light area.

### CROSS-REFERENCE TO RELATED PATENT APPLICATION

This application claims the benefit of Korean Patent Application No. 10-2005-0090758, filed on Sep. 28, 2005, in the Korean Intellectual Property Office, the disclosure of which is incorporated herein in its entirety by reference.

### BACKGROUND OF THE INVENTION

1. Field of the Invention

The present invention relates generally to a Light Guide Panel (LGP) for a back light unit, and a method of manufacturing the LGP, and more particularly, to a LGP receiving light from a light source to uniformly distribute the light throughout the LGP, a back light unit including the LGP, and a method of manufacturing the LGP.

2. Description of the Related Art

Liquid Crystal Displays (LCDs) use a kind of light switch phenomenon. In this light switch phenomenon, a liquid crystal, which is a material intermediate a solid and a liquid state, is injected between upper and lower thin glass panels. Orientation of the liquid crystal molecules is controlled using a voltage difference between electrodes on the upper and lower glass panels so as to generate a contrast. As a result, figures or images are displayed using the contrast.

Such a LCD is non-luminescent unlike a Cathode Ray Tube (CRT), a Plasma Display Panel (PDP), and a Field Emission Display (FED). That is, the LCD cannot display an image without a light source. Thus, the LCD requires an apparatus operating as a light source to uniformly radiate light on an information display surface.

Accordingly, the LCD requires a back light unit that is used to uniformly transmit light throughout a TFT-LCD panel for displaying an image using the transmitted light.

Such a back light unit is used as a light source for a TFT-LCD employed in a monitor, a notebook computer, or the like and thus requires a function of emitting maximally bright light using a minimum power. Also, the back light unit uniformly maintains the brightness of the light emitted from the light source throughout a surface of the LCD so as to convert the light into sheet light.

As shown in FIG. 1, a back light unit includes a light source 1, an LGP 3, a light spreading sheet 4, a prism sheet 5, a polarizing film 6, and a reflector 2.

The light source 1 is generally a Cathode Fluorescent Lamp (CFL), particularly a cold CFL (CCFL), and the LGP 3 is disposed proximate to the light source 1. The prism sheet 5 and the polarizing film 6 are sequentially disposed over a light emission surface of the LGP 3, and the reflector 2 is disposed opposite to the light emission surface of the LGP 3. The light spreading sheet 4 spreads and scatters light from the LGP 3 to maintain a uniform luminance of the light on substantially an entire area of a screen that may be disposed in front of the LGP 3.

A dot pattern is formed of a coating on a rear surface of the LGP 3 to uniformly emit the light incident from the light source 1 to any position of the screen. A printing pattern formed on the rear surface of the LGP 3 to scatter light is called a pseudo light source. A light beam emitted from the light source 1 is diffused and reflected by the dot pattern on the rear surface of the LGP 3 and emitted forward from the light emission surface of the LGP 3.

The reflector 2 is positioned on the rear surface of the LGP 3 to reflect the light beam emitted from the light source 1. Here, almost all portion of emitted light is emitted greatly deviating from a vertical direction of the LGP 3 due to the light beam emitted from the light source 1. Also, the distribution of the light remarkably deviates. Thus, a user observing the LGP 3 from the vertical direction of the LGP 3 generally sees a very dark LCD screen.

To solve this problem, the prism sheet 5 and the polarizing film 6 are disposed in a front of the LGP 3. The prism sheet 5 increases a luminance of light reflected in front of the prism sheet 5. The polarizing film 6 transmits only uniformly polarized light. In this case, the polarizing film 6 transmits a P wave (parallel) component (hereinafter P wave) and absorbs an S wave (perpendicular) component (hereinafter S wave). An image is formed on a liquid crystal panel due to the uniformly polarized P wave light.

The polarizing film 6 divides light incident thereon into P and S wave components and absorbs the S wave component. Thus, a transmittance of the S wave is about 5% when compared to a transmittance of the P wave of about 85%, and 10% of incident light intensity is absorbed or reflected into or by the polarizing film 6. As can be appreciated, light incident on the LCD panel through the polarizing film 6 is considerably lost.

Also, manufacturing unit cost for the polarizing film 6 is high. As a result, manufacturing unit cost for the entire back light unit is increased.

In addition, a polarizing film must be additionally assembled when a back light unit is manufactured. Thus, an assembling process is complicated.

### SUMMARY OF THE INVENTION

The present invention provides a back light unit transmitting only uniformly polarized light without a polarizing film, an LGP of the back light unit, and a method of manufacturing the LGP.

The present invention also provides a back light unit transmitting light with a small amount of light loss, simply assembled, and reducing its manufacturing unit cost, an LGP of the back light unit, and a method of manufacturing the LGP.

According to an aspect of the present invention, there is provided a light guide panel used for a back light unit, including: a light guide panel body including an incidence surface receiving light irradiated from a back light source and an emission surface emitting the received light; and a polarizing coating layer positioned above the emission surface and comprising at least one coating layer coated with an inorganic compound having a refractive index of at least 2.0. Here, a difference between transmittances of P and S wave of polarized light having passed through the polarizing coating layer from the light guide panel body may be at least 50% in a visible light wavelength range.

According to another aspect of the present invention, there is provided a back light unit including: a back light source; a light guide panel receiving light from the back light source and emitting the light exterior to the panel; a reflector formed opposite to an emission surface of the light guide panel to reflect light emitted from the light guide panel toward the emission surface; and a light controller refracting or reflecting the light emitted from the light guide panel to control the light irradiated to the outside to be uniformly distributed.

According to still another aspect of the present invention, there is provided a method of manufacturing a light guide panel used for a back light unit, including: forming from a poly methyl methacrylate a light guide panel body including an incidence surface for receiving light irradiated from a back light source and an emission surface for emitting the received light and; cleaning the light guide panel body; forming a hard coating layer on the emission surface of the light guide panel body using a hard coating solution; and forming a polarizing coating layer on the hard coating layer.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view of an LGP used for a conventional back light unit;

FIG. 2 is a cross-sectional view of a back light unit according to an embodiment of the present invention;

FIG. 3 is a cross-sectional view of portion A shown in FIG. 2, i.e., a cross-sectional view of an LGP according to an embodiment of the present invention FIG. 4 is a graph illustrating relationships between inorganic compounds of which a polarizing coating is formed and their thicknesses;

FIG. 5 is a cross-sectional view of the portion A shown in FIG. 2, i.e., a cross-sectional view of an LGP according to another embodiment of the present invention;

FIG. 6 is a graph illustrating transmittances of P and S waves of the LGP of FIG. 5 having a polarizing coating layer;

FIG. 7 is a cross-sectional view of the portion A shown in FIG. 2, i.e., a cross-sectional view of an LGP according to still another embodiment of the present invention;

FIG. 8 is a graph illustrating transmittances of P and S waves of the LGP of FIG. 7 having a polarizing coating layer;

FIG. 9 is a cross-sectional view of a first modification of the LGP shown in FIG. 7;

FIG. 10 is a graph illustrating transmittances of P and S waves of the LGP of FIG. 9 having a polarizing coating layer;

FIG. 11 is a cross-sectional view of a second modification of the LGP shown in FIG. 7;

FIG. 12 is a graph illustrating transmittances of P and S waves of the second modification of FIG. 11 having a polarizing coating layer according to an embodiment of the present invention;

FIG. 13 is a graph illustrating transmittances of P and S waves of the second modification of FIG. 11 having a polarizing coating layer according to another embodiment of the present invention;

FIG. 14 is a graph illustrating transmittances of P and S waves of the second modification of FIG. 11 according to still another embodiment of the present invention;

FIG. 15 is a cross-sectional view of a third modification of the LGP shown in FIG. 7;

FIG. 16 is a graph illustrating transmittances of P and S waves of the third modification of FIG. 15 having a polarizing coating layer; and

FIG. 17 is a flowchart of a method of manufacturing an LGP used for a back light unit according to an embodiment of the present invention.

### DETAILED DESCRIPTION OF THE EMBODIMENTS

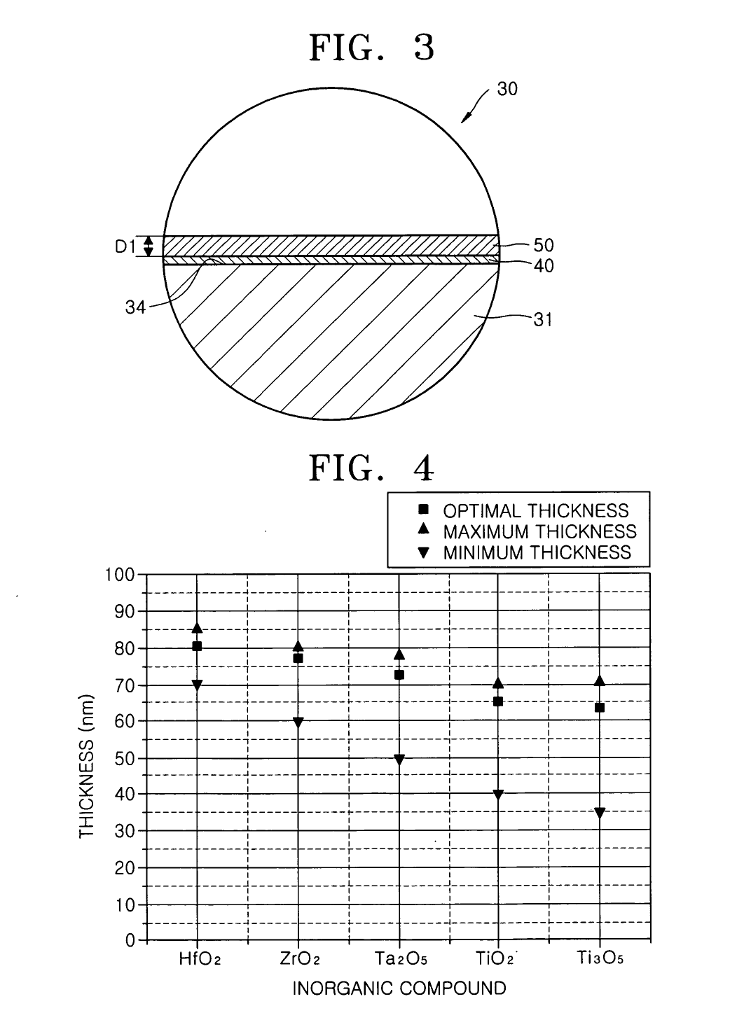

FIG. 2 is a schematic cross-sectional view of a back light unit according to a aspect of the present invention. Referring to FIG. 2, a back light unit 10 includes a prism sheet 60, an LGP 30, a back light source 11, and a reflector 20. A liquid crystal display panel 70 or the like may be disposed above the prism sheet 60 for illumination thereof.

The back light source 11 may be a CFL, for example a CCFL. However, the back light source 11 may be other types of lights known in the art. A process of emitting light from the back light source 11 embodied as a CCFL will now be described. If a voltage is applied to the back light source 11, electrons remaining inside the back light source 11 move to an anode. The electrons clash against argon (Ar), and thus the argon (Ar) is excited to multiply positive ions. The multiplied positive ions clash against the anode to emit secondary electrons. If the secondary electrons flow inside a tube to start a discharge, the electrons clash against mercury (Hg) vapor and thus are ionized so as to emit ultraviolet rays and visible light. The emitted ultraviolet rays excite a fluorescent substance coated on an inner wall of the CFL to emit visible light so as to irradiate light.

The LGP 30 is disposed proximate to and is oriented generally in a planar relationship with the back light source 11. The LGP 30 functions as a waveguide allowing light emitted from the back light source 11 to be incident inward to emit sheet light toward an emission surface (an upper portion shown in FIG. 2) and polarizing light.

The reflector 20 is installed opposite to the emission surface of the LGP 30 to reflect the light emitted from the back light source 11 toward the inside of the LGP 30.

The prism sheet 60 may include sheets 61 and 62 (e.g., vertical and horizontal sheets) as shown in FIG. 2 or may be formed as one sheet. The prism sheet 60 increases a front luminance of light passing therethrough. In other words, the prism sheet 60 transmits only light incident at a specific angle but totally reflects light incident at the other angles so that the light returns to a lower portion of the prism sheet 60. As described above, the returning light is reflected by the reflector 20.

The back light unit 10 including the above-described elements may be combined or otherwise assembled in a mold frame 15. The liquid crystal panel 70 is disposed above the back light unit 10 and may be protected by a top-chassis (not shown). In this case, the top-chassis and the mold frame 15 may be combined with each other so that the back light unit 10 and the liquid crystal panel 70 are positioned between the top-chassis and the mold frame 15.

As shown in FIG. 3, the LGP 30 includes an LGP body 31 and a polarizing coating layer 50. If light is incident on the LGP body 31 from the back light source 11 through an incidence surface 32 (FIG. 2), the LGP body 31 diffuses and reflects the incident light so as to transmit the light through an emission surface 34 (the top surface).

The LGP body 31 may be formed of a poly methyl methacrylate (PMMA). PMMA is a methacrylate-family plastic resin, i.e., a linear polymer, having a high light permeability, a high surface strength, and a high wear resistance. PMMA is less costly than ZEONEX® or Topas® that are employed for manufacturing optical components.

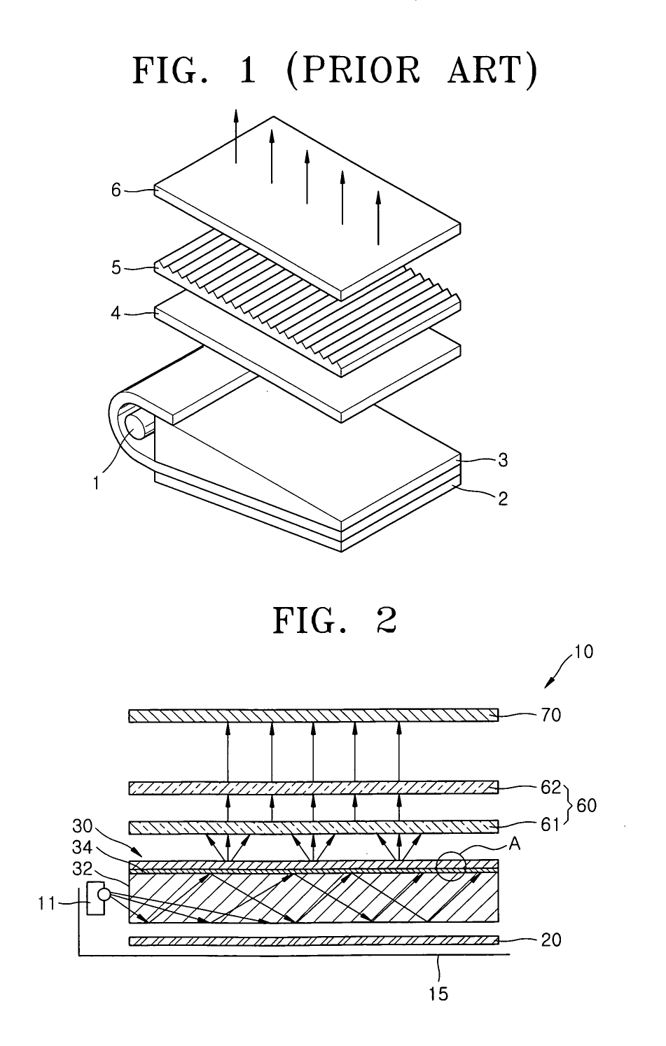

The polarizing costing layer 50 is disposed above the emission surface 34 of the LGP body 31. The polarizing coating layer 50 is formed of an inorganic compound to polarize light having passed through the LGP body 31. In other words, unlike the conventional back light unit, an additional polarizing film (e.g., film 6 of FIG. 1) is not required.

However, PMMA absorbs a large amount of moisture at an ambient temperature, and thus a mold release wax, oil or dust is prone to stick to a surface of the PMMA during injection molding. Thus, it is difficult to apply a polarizing coat of an inorganic material directly on the PMMA. In addition, the PMMA is sensitive to a variation in a temperature. Therefore, to solve this problem and improve an adhesion of the polarizing coating layer 50 on the LGP body 31, a hard coating layer 40 may first be formed on the emission surface 34 of the LGP body 31. Subsequent to formation of the hard coating layer 40, the polarizing coating layer 50 may be formed on the hard coating layer 40. The hard coating layer 40 may be formed of, for example, ST104GN-S or ST31GN-S produced by LG Chem, Ltd. Of course, the hard coating layer 40 may be other suitable materials known in the art.

The LGP body 31 of the present invention is not limited to PMMA and may be formed of other suitable materials such as ZEONEX® or Topas®. In a case where the LGP body 31 is formed of ZEONEX® or Topas®, hygroscopicity is lower than PMMA and the hard coating layer 40 does not need to be interposed between the polarizing coating layer 50 and the LGP body 31.

The inorganic material of which the polarizing coating layer 50 is formed is selected so that in a visible light wavelength range (i.e., between about 400 nm and about 700 nm), the polarizing coating layer 50 has a refractive index of at least 2.0. Although one polarizing coating layer 50 is shown in FIG. 3, the polarizing coating layer 50 may be formed by laminating a plurality of layers.

Embodiments of the present invention will now be described with respect to the polarizing coating layer 50 including one or more (i.e., stacked) layers.

The polarizing coating layer 50 of the LGP 30 used for the back light unit according to an embodiment of the present invention may be formed of a single layer as shown in FIG. 3.

In this case, an inorganic compound of which the polarizing coating layer 50 is formed has a refractive index of at least 2.0 and a thickness D between about 35 nm and about 85 nm. The inorganic compound may be ZrO₂, HfO₂, Ta₂O₅, TiO₂, Ti₃O₅, Ti₂O₃, ZnS, or ZnSe. In a case where the polarizing coating layer 50 is manufactured under the above-described conditions, a transmittance of a P wave is about 90% or more and a transmittance of an S wave is about 40% or less in a visible light wavelength range (i.e., a wavelength between 400 nm and 700 nm).

A thickness of the inorganic compound may be adjusted to give a high polarization characteristic. If the thickness of the inorganic compound exceeds or is less than an optimal condition, the polarization characteristic is deteriorated. As a result, the transmittance of the P wave may be less than 90% and the transmittance of the S wave is greater than 40%.

A thickness D for optimizing polarization of the polarizing coating layer 50 formed from the inorganic compound will now be described with reference to FIG. 4. In a case where the polarizing coating layer 50 is formed of HfO₂, the thickness D of the polarizing coating layer 50 may be within a range between about 70 nm and about 85 nm. In a case where the polarizing coating layer 50 is formed of ZrO₂, the thickness D of the polarizing coating layer 50 may be within a range between about 60 nm and about 80 nm. In a case where the polarizing coating layer 50 is formed of Ta₂O₅, the thickness D of the polarizing coating layer 50 may be within a range between about 50 nm and about 80 nm. In a case where the polarizing coating layer 50 is formed of TiO₂, the thickness D of the polarizing coating layer 50 may be within a range between about 40 nm and about 70 nm. In a case where the polarizing coating layer 50 is formed of Ti₃O₅, the thickness D of the polarizing coating layer 50 may be within a range between about 35 nm and about 70 nm.

If the inorganic compound is Ti₃O₅ and a thickness of the inorganic compound is less than about 35 nm, a transmittance of the S wave is increased to about 40% or more in a long wavelength range (i.e., 650 nm or more), and thus, a polarization function is deteriorated. If the thickness of the inorganic compound exceeds about 70 nm, the transmittance of the S wave is increased to about 40% or more in a short wavelength range (i.e., about 430 nm), and thus the polarization function is deteriorated.

A plurality of coating layers may be stacked to form a polarizing coating layer so as to improve efficiency of a polarization characteristic.

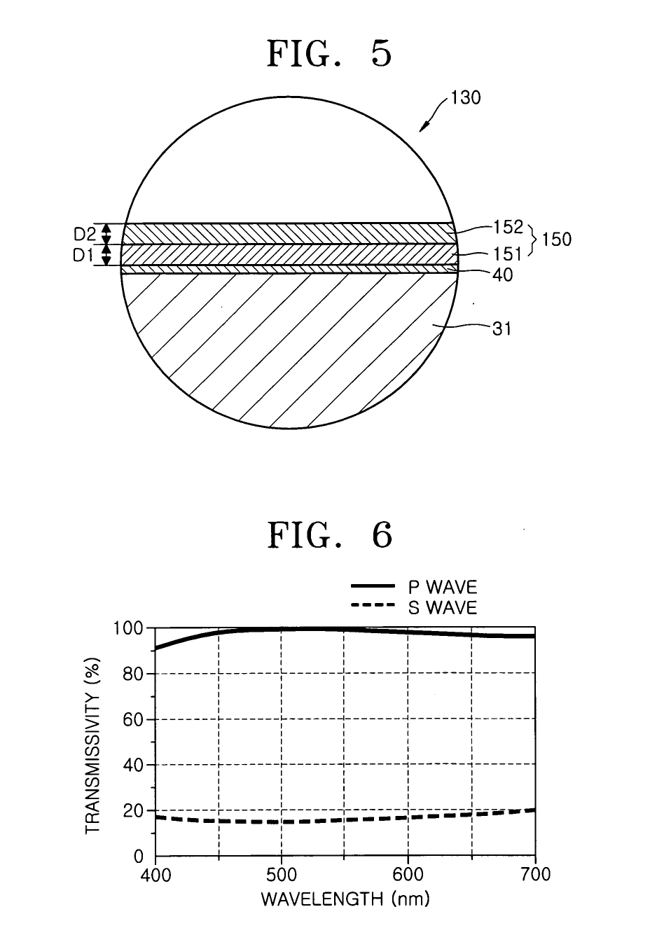

In this case, as shown in FIG. 5, a polarizing coating layer 150 of an LGP 130 according to another embodiment of the present invention may include a first coating layer 151 coated on the hard coating layer 40 and a second coating layer 152 coated on the first coating layer 151.

The first coating layer 151 has a lower refractive index than the second coating layer 152. For example, an inorganic compound of which the first coating layer 151 is formed may be Na₃AlF₆, MgF₂, SiO₂, CaF₂, or LaF₃ having a refractive index less than 2.0, and an inorganic compound of which the second coating layer 152 is formed may be ZrO₂, HfO₂, Ta₂O₅, TiO₂, Ti₃O₅, Ti₂O₃, ZnS, or ZnSe having a refractive index exceeding 2.0.

Here, a difference between the refractive indexes of the first and second coating layers 151 and 152 may be at least 0.7. For example, if the first coating layer 151 has a refractive index of 1.38, the second coating layer 152 is formed to have a refractive index of 2.08 or more.

If the first coating layer 151 is formed of MgF₂ and the second coating layer 152 is formed of Ti₃O₅, the first coating layer 151 may have a thickness between about 170 nm and about 190 nm, and the second coating layer 152 may have a thickness between about 50 nm and about 70 nm. In this case, as shown in FIG. 6, a transmittance of a P wave of a polarizing coating layer is about 95% or more and a transmittance of an S wave of the polarizing coating layer is about 30% or less in a visible light wavelength range.

As shown in FIGS. 5, 7, 9, 11 and 15, an LGP 230 used for a back light unit according to still another aspect of the present invention may include a polarizing coating layer 250 that is formed of a plurality of (e.g., between two and ten) layers.

As can be appreciated, the polarizing coating layer 250 may be formed of two or more (e.g., first and second) alternating coating layers. In this case, a difference between refractive indexes of the alternating first and second coating layers may be at least 0.7. In this case, the first coating layer may have a higher refractive index compared to the second coating layer to improve a polarization performance. Furthermore, each of the first and second coating layers may have a thickness between about 2 nm and about 300 nm.

In this case, an inorganic compound of which one of the first and second coating layers may be Na₃AlF₆, MgF₂, SiO₂, CaF₂, or LaF₃. An inorganic compound of which the other one of the first and second coating layers may be ZrO₂, HfO₂, Ta₂O₅, TiO₂, Ti₃O₅, Ti₂O₃, ZnS, or ZnSe.

Some example combinations for the first and second coating layers may be: a combination of SiO₂/Ta₂O₅, a combination of SiO₂/TiO₂, a combination of SiO₂/Ti₃O₅, a combination of MgF₂/Ta₂O₅, a combination of MgF₂/TiO₂, or a combination of MgF₂/Ti₃O₅.

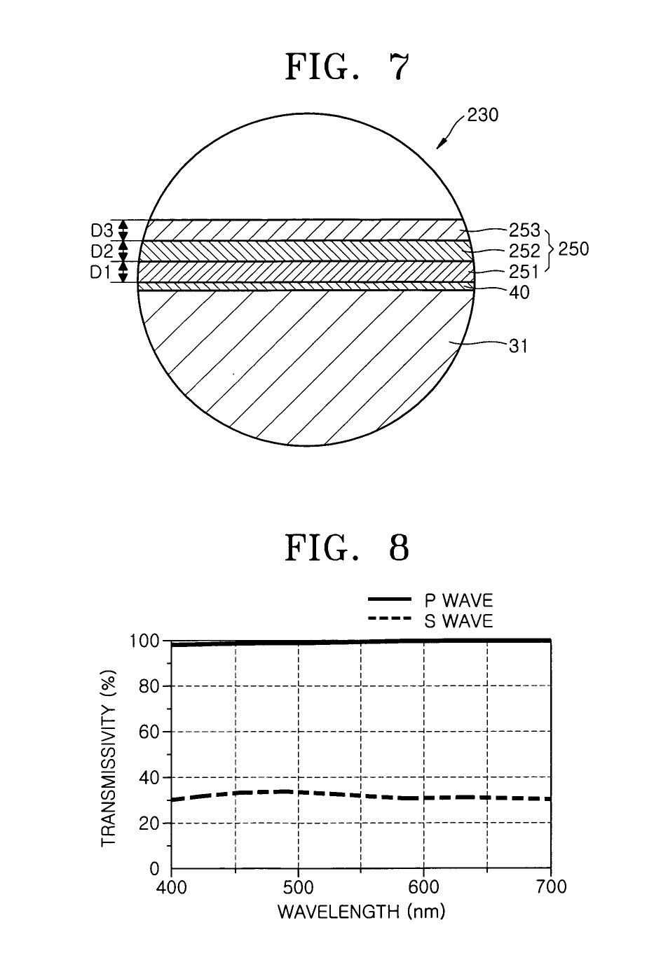

Referring now to FIG. 7, the polarizing coating layer 250 may be formed of three layers in which a first coating layer 251, a second coating layer 252, and a first coating layer 253, wherein the layers 251, 252 and 253 are sequentially stacked on the hard coating layer 40. In this case, the first coating layer 251 that is a lowermost layer may have a thickness D1 between about 5 nm and about 20 nm, the second coating layer 252 that is an intermediate layer may have a thickness D2 between about 30 nm and about 50 nm, and the third coating layer 253 that is an uppermost layer may have a thickness D3 between about 60 nm and about 80 nm. A difference between a transmittance of a P wave and a transmittance of an S wave is the greatest in this case. According to the result of an experiment of the present invention, the polarizing coating layer 250 shown in FIG. 7 and described above transmits about 100% of the P wave but about 30% of the S wave in a visible light wavelength range as shown in FIG. 8.

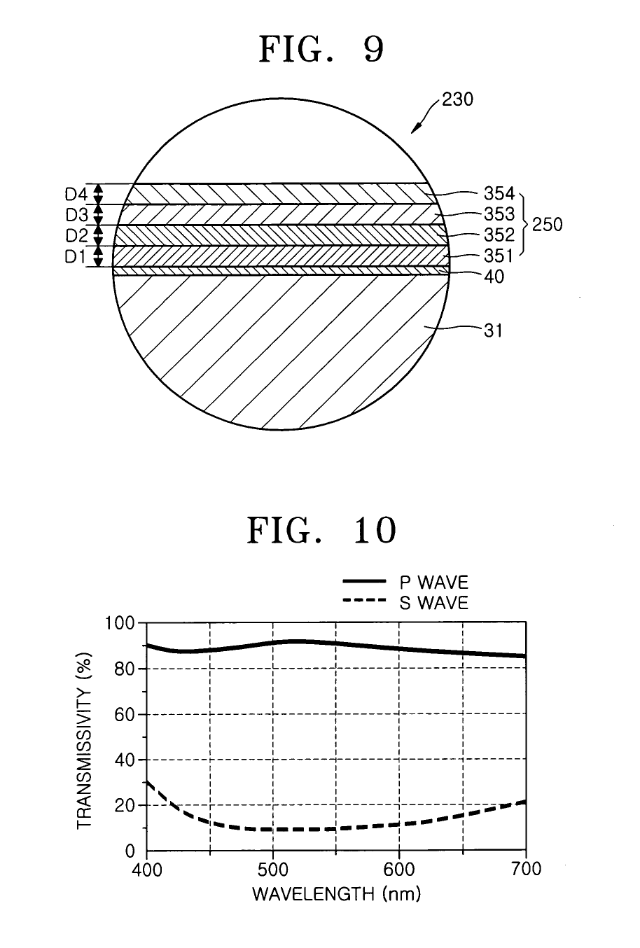

In yet another embodiment as shown in FIG. 9, the polarizing coating layer 250 may be formed of four layers in which a first coating layer 351 has a thickness D1 between about 60 nm and about 80 nm, a second coating layer 352 has a thickness D2 between about 100 nm and about 120 nm, a third coating layer 353 has a thickness D3 between about 50 nm and about 70 nm, and a fourth coating layer 354 has a thickness D4 between about 2 nm and about 10 nm and wherein the layers 351-354 are sequentially stacked on the hard coating layer 40. In this case, according to the result of an experiment of the present invention, the polarizing coating layer 250 transmits about 90% of a P wave but less than about 30% of an S wave in a visible light wavelength range as shown in FIG. 10.

As shown in FIG. 11, the polarizing coating layer 250 may be formed of five layers in which first, second, third, fourth, and fifth coating layers 451, 452, 453, 454, and 455 are sequentially stacked on the hard coating layer 40.

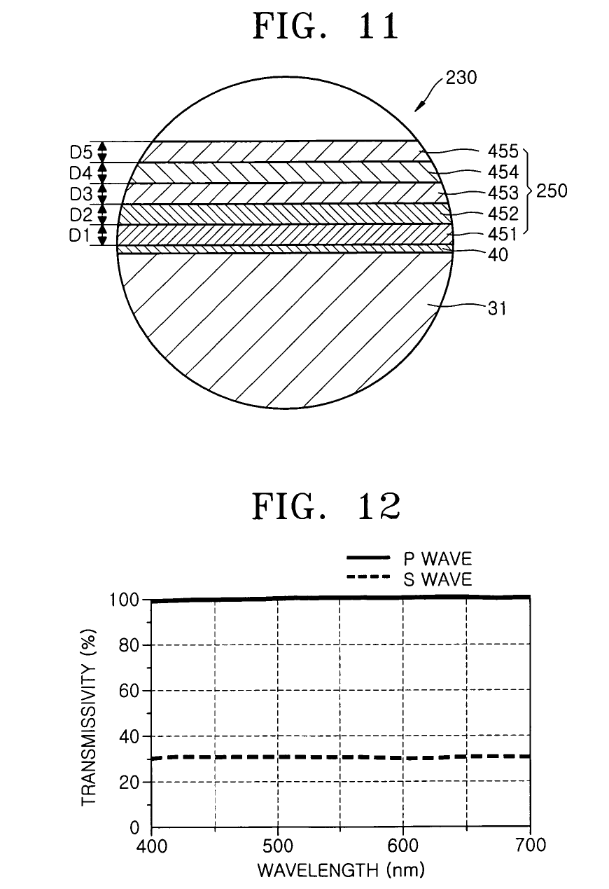

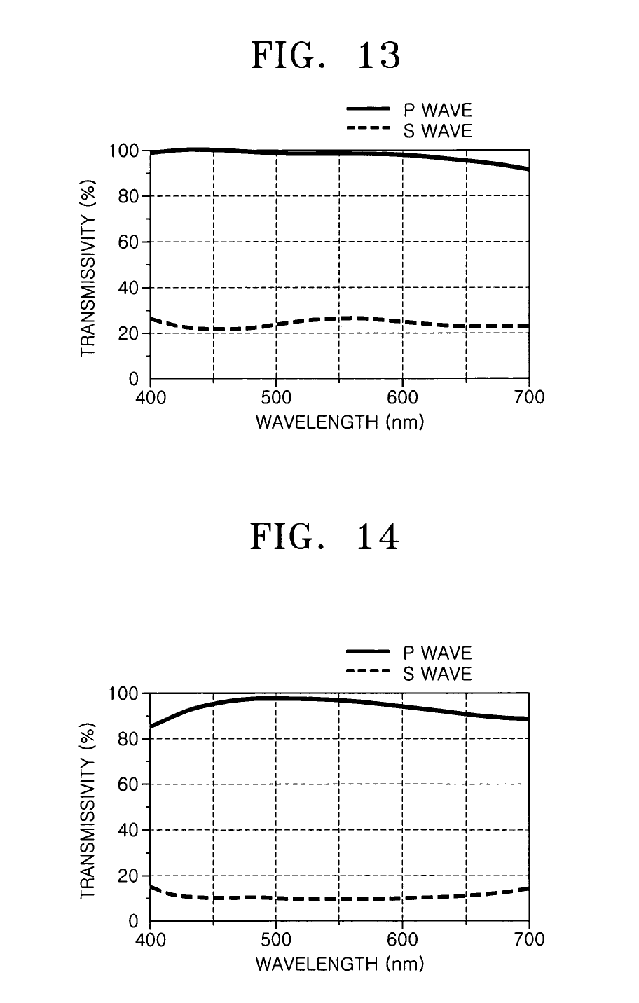

As an example, the first coating layer 451 may have a thickness D1 between about 2nm and about 15 nm, the second coating layer 452 may have a thickness D2 between about 30 nm and about 50 nm, the third coating layer 453 may have a thickness D3 between about 3 nm and about 20 nm, the fourth coating layer 454 may have a thickness D4 between about 5 nm and about 30 nm, and the fifth coating layer 455 may have a thickness D5 between about 50 nm and about 70 nm. In this case, according to the result of an experiment of the present invention, the polarizing coating layer 250 transmits about 100% of a P wave but about 30% of an S wave in the visible light wavelength range as shown in FIG. 12.

As another example, first through fifth coating layers stacked on the hard coating layer 40 may respectively have thicknesses between about 5 nm and about 20 nm, between about 30 nm and about 50 nm, between about 100 nm and about 120 nm, between about 160 nm and about 180 nm, and between about 30 nm and about 50 nm. In this case, according to the result of an experiment of the present invention, the polarizing coating layer 250 transmits about 100% of a P wave but less than about 30% of an S wave as shown in FIG. 13.

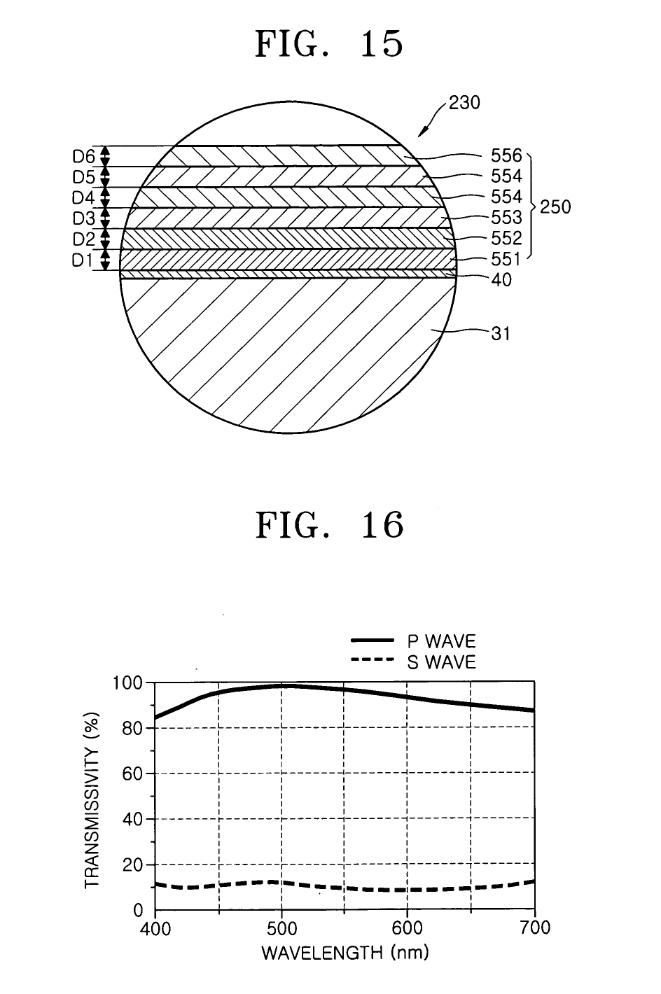

As another example, through fifth coating layers stacked on the hard coating layer 40 may respectively have thicknesses between about 10 nm and about 30 nm, between about 20 nm and about 40 nm, between about 60 nm and about 80 nm, between about 130 nm and about 150 nm, and between about 50 nm and about 70 nm. In this case, according to the result of an experiment of the present invention, the polarizing coating layer 250 transmits about 80% or more of a P wave and about 20% or less of an S wave as shown in FIG. 14.

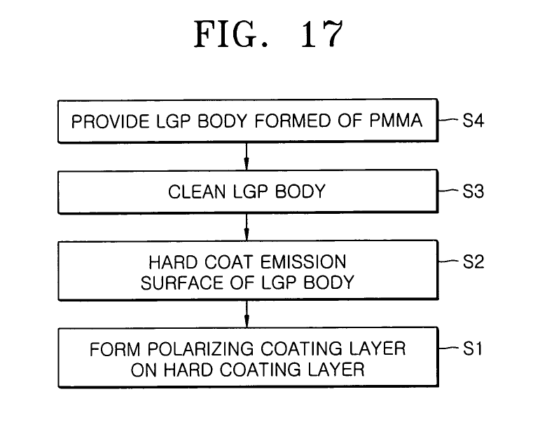

As shown in FIG. 15, the polarizing coating layer 250 may be formed of six layers in which first, second, third, fourth, fifth, and sixth coating layers 551, 552, 553, 554, 555, and 556 are sequentially stacked on the hard coating layer 40. In this case, the polarizing coating layer 250 may be formed by sequentially stacking the first coating layer 551 having a thickness D1 between about 110 nm and about 130 nm, the second coating layer 552 having a thickness D2 between about 10 nm and about 30 nm, the first coating layer 553 having a thickness D3 between about 30 nm and about 50 nm, the second coating layer 554 having a thickness D4 between about 60 nm and about 80 nm, the first coating layer 555 having a thickness D5 between about 130 nm and about 150 nm, and the second coating layer 556 having a thickness D6 between about 50 nm and about 70 nm on the hard coating layer 40. In this case, according to the result of an experiment of the present invention, the polarizing coating layer 250 transmits about 85% or more of a P wave but about 15% or less of an S wave in a visible light wavelength range as shown in FIG. 16.

FIG. 17 is a flowchart illustrating example steps of a method for manufacturing an LGP according to an embodiment of the present invention. A method of manufacturing the LGP 30 used for a back light unit according to an embodiment of the present invention will now be described in detail with reference to FIGS. 17 and 3.

The method includes operation S1 of providing the LGP body 31, operation S2 of cleaning the LGP body 31, operation S3 of hard coating the emission surface 34 of the LGP 30, and operation S4 of forming the polarizing coating layer 50.

In operation S1, the LGP body 31 is formed of a suitable material such as PMMA so that the body 31 includes the incidence surface 32 (refer to FIG. 2) for receiving light irradiated from the back light source I1 (refer to FIG. 2) and the emission surface 34 for emitting the received light.

In operation S2, the LGP body 31 is cleaned, particularly if the LGP body 31 is formed of a methacrylate-family plastic resin such as PMMA. Since, PMMA absorbs a large amount of moisture at an ambient temperature, often a mold release wax, oil or dust sticks to a surface of the PMMA during and/or after injection molding. Thus, it is difficult to perform polarization coating on the surface of the PMMA using an inorganic material. Therefore, to solve this problem, operation S2 may be performed before hard coating.

The cleaning operation S2 may employ an ultrasonic cleaning method using a liquid. A liquid not melting or otherwise damaging the PMMA such as clean water, deionized water, ethanol, Iso Propyl Alcohol (IPA), or detergent is disposed in a container such as a cleaning bath and then ultrasonic waves are applied to the cleaning bath. When the LGP body 31 is inserted into the cleaning bath, the material such as dust sticking to the surface of the LGP body 31 is removed by the vibration of the ultrasonic waves.

Here, the ultrasonic wave frequency and liquid may be selected so as not to scratch the surface of the LGP body 31. Furthermore, a cleaning time (e.g., not to exceed 1 minute) may be selected to reduce a permeation of moisture into the LGP body 31. Also, when the ultrasonic waves continuously vibrate, a temperature of the liquid is increased. Here, a temperature of the cleaning bath is preferred not to exceed about 80°. Of course other suitable temperatures of the liquid may be selected according to cleaning time, frequency, type of liquid, etc. The present invention is not limited to an ultrasonic cleaning method and may alternatively use one or more cleaning methods known in the art such as a method of using a gas such as clean air, nitrogen, or the like, a minute cleaning method using plasma, and the like.

In operation S3, the LGP body 31 is hard coated. The hard coating may be performed using, for example, a spin coater. The spin coater can coat a planar object with a layer of material by depositing the material on the object and rotating the object. Here, the spin coater may have a strong rotating force to uniformly spread a solution on the LGP body 31. Also, in the case of the spin coating method, the solution is uniformly coated on a surface of a lens using centrifugal force. Thus, if a rotating speed is properly adjusted, one or more optimal coating conditions may be found. As a result, a speed-maintaining time, a speed-increasing time, and the like of the spin coating method may be adjusted.

In an example spin coating process, the LGP body 31 is mounted in the spin coater. The emission surface 34 of the LGP body 31 may rotate at a speed so as to uniformly distribute the liquid thereon.

A predetermined amount of solution drops on the emission surface 34 of the LGP body 31 to be coated, and then the LGP body 31 slowly rotates. Here, if the LGP body 31 rotates fast from the start, the hard solution may not be uniformly coated on the surface of the LGP body 31 but, rather, become spun off from the surface of the LGP body 31. Therefore, the rotating speed of the LGP body 31 is about 50 rpm and is then increased to about 1000 rpm when the solution is uniformly coated on the body 31. The first low rotating speed is to ensure a uniform coating of the solution, and the high speed rotating speed is used to thin out the uniform coat of the solution. Also, if the solution drops during the rotation of the LGP body 31, the solution may splash causing air bubbles to occur in the hard coating layer 40. Thus, to prevent this, the solution may be poured by a predetermined amount before the body 31 rotates.

The present invention is not limited to the spin coating method. In other words, the present invention may use various methods such as a dipping method of dipping a lens into a bath containing a solution and then removing the lens out of the bath, a method of spraying a solution on a rotating lens to uniformly coat the solution on the rotating lens, a spraying method of spraying a solution on the lens using a small nozzle, or the like.

After the solution is applied to the body 31, a drying process may be performed to harden or otherwise cure the solution. The drying process may be performed in a dryer having a temperature between about 80° and about 90° for between about 2 to about 4 hours. After the solution is hardened or cured, an inorganic compound may be coated on the hard coating layer 40 on the LGP body 31.

The polarizing coating layer 50 is formed in operation S1. Here, an inorganic compound of which the polarizing coating layer 50 is formed may be deposited in a vacuum chamber. The inorganic compound may be MgF₂, SiO₂, Ta₂O₅, Ti₂O₃, TiO₂, Ti₃O₅, CeO₂, or a combination of a plurality of materials. A thin film of the inorganic compound may be formed by, for example, thermal evaporation depositing, electron gun depositing, or sputter depositing these chemicals in a vacuum state. In this case, the polarizing coating layer 50 may be formed of a single layer or a plurality of layers as described above.

If hard coating is performed with respect to a substrate to control stripping of an inorganic compound thin film, a desired thickness of the inorganic compound thin film may be deposited on the substrate using an evaporation method as described above to obtain a polarized beam split performance. However, an ion gun or an Advanced Plasma Source (APS) gun may be used to deposit a more precise, durable thin film so as to improve the density of the thin film. As a result, the durability of the thin film can be increased.

A coating process of the present invention concentrates on optimizing polarization. In other words, a transmittance of a P wave must be high and a transmittance of an S wave must be low (i.e., S wave reflectance must be high). Thus, the coating process of the present invention is different from an Anti-Reflection (AR) coating for reducing a reflectance occurring on an interface between a substrate and air to reduce a reflectance.

A coating structure of the present invention is different from an existing coating structure in that it has a plastic/coating/air structure, i.e., a 2-dimensional structure nearly neglecting a height compared to a width.

As described above, according to the present invention, a coating process can be performed on an LGP body to polarize light. Thus, cost can be reduced by about 15-20% as compared to a conventional polarizing film.

Also, a polarizing film can be removed so as to simplify an assembling process.

In addition, a polarizing method using the coating process of the present invention does not use an absorption of light. Thus, incident light is hardly lost.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A light guide panel for a back light unit including a light source, comprising:
a light guide panel body including an incidence surface configured to receive a light irradiated from the light source and an emission surface configured to substantially emit the light as a sheet light; and
a polarizing coating layer positioned above the emission surface and having a refractive index of at least 2.0,
wherein a difference between a P wave transmittance and an S wave transmittance of the sheet light having passed through the polarizing coating layer is at least 50% in a visible light wavelength range.

2. The light guide panel of claim 1, wherein the polarizing coating layer is a single layer having a thickness between about 35 nm and about 85 nm.

3. The light guide panel of claim 1, wherein the polarizing coating layer is an inorganic compound selected from the group consisting of ZrO₂, HfO₂, Ta₂O₅, TiO₂, Ti₃O₅, Ti₂O₃, ZnS, and ZnSe.

4. The light guide panel of claim 3, wherein the polarizing coating layer is Ti₃O₅ and has a thickness between about 35 nm and about 70 nm.

5. The light guide panel of claim 2, wherein:
the light guide panel body is PMMA; and
a hard coating layer is interposed between the light guide panel body and the polarizing coating layer.

6. The light guide panel of claim 1, wherein the polarizing coating layer comprises:
a first coating layer of a first inorganic compound and having a first refractive index; and
a second coating layer of a second inorganic compound and having a second refractive index, a difference between the first and second refractive indexes being at least 0.7.

7. The light guide panel of claim 6, wherein:
the first coating layer has a thickness between about 170 nm and about 190 nm; and
the second coating layer has a thickness between about 50 nm and about 70 nm.

8. The light guide panel of claim 6, wherein:
the first inorganic compound is selected from the group consisting of Na₃AlF₆, MgF₂, SiO₂, CaF₂, and LaF₃; and
the second inorganic compound is selected from the group consisting of ZrO₂, HfO₂, Ta₂O₅, TiO₂, Ti₃O₅, Ti₂O₃, ZnS, and ZnSe.

9. The light guide panel of claim 6, wherein:
the light guide panel body is PMMA; and
a hard coating layer is interposed between the light guide panel body and the polarizing coating layer.

10. The light guide panel of claim 1, wherein the polarizing coating layer comprises three to ten layers formed of an alternating arrangement of first and second coating layers, each of the three to ten layers having a thickness between about 2 nm and about 300 nm, and
wherein a difference between a refractive index of the first coating layer and a refractive index of the second coating layer is at least 0.7.

11. The light guide panel of claim 10, wherein at least one of the first and second coating layers has a refractive index of at least 2, and the other one of the first and second coating layers has a refractive index of at least 1.65.

12. The light guide panel of claim 11, wherein:
one of the first and second coating layers is formed of at least one material that is selected from the group consisting of Na₃AlF₆, MgF₂, SiO₂, CaF₂, and LaF₃; and
the other one of the first and second coating layers is formed of at least one material that is selected from the group consisting of ZrO₂, HfO₂, Ta₂O₅, TiO₂, Ti₃O₅, Ti₂O₃, ZnS, and ZnSe.

13. The light guide panel of claim 12, wherein the first and second coating layers are selected from the group consisting of: SiO₂/Ta₂O₅, SiO₂/TiO₂, SiO₂/fTi₃O₅, MgF₂/Ta₂O₅, MgF₂/TiO₂, and MgF₂/Ti₃O₅.

14. The light guide panel of claim 11, wherein the first coating layer has a higher refractive index than the second coating layer.

15. The light guide panel of claim 11, wherein the polarizing coating layer further comprises a third coating layer laminated with the first and second coating layers, and
wherein the third coating layer has a thickness between about 60 nm and about 80 nm, the first coating layer has a thickness between about 5 nm and 20 nm, and a second coating layer has a thickness between about 30 nm and about 50 nm.

16. The light guide panel of claim 10, wherein:
the light guide panel body is PMMA; and
a hard coating layer is interposed between the light guide panel body and the polarizing coating layer.

17. A back light unit comprising:
a back light source;
a light guide panel including a light guide panel body having an incidence surface for receiving light from the back light source, an emission surface for emitting the light to an outside, and a polarizing coating layer having a refractive index of at least 2.0, the polarizing coating layer being positioned above the emission surface and formed of an inorganic compound;
a reflector configured opposite to the emission surface for reflecting light toward the emission surface; and
a light controller configured on the light guide panel for uniformly distributing the light substantially on an entire area of the emission surface

18. The back light unit of claim 17, wherein the polarizing coating layer is a single layer having a thickness between about 35 nm and about 85 nm.

19. The back light unit of claim 17, wherein:
the light guide panel body is PMMA; and
a hard coating layer is interposed between the light guide panel body and the polarizing coating layer.

20. The back light unit of claim 17, wherein the polarizing coating layer comprises:
a first coating layer of a first inorganic compound and having a first refractive index; and
a second coating layer of a second inorganic compound and having a second refractive index, a difference between the first and second refractive indexes being at least 0.7.

21. The back light unit of claim 17, wherein the polarizing coating layer comprises three to ten layers formed of an alternating arrangement of first and second coating layers, each of the three to ten layers having a thickness between about 2 nm and about 300 nm, and
wherein a difference between a refractive index of the first coating layer and a refractive index of the second coating layer is at least 0.7.

22. A method of manufacturing a light guide panel for use with a back light unit, the method comprising:
forming a light guide panel body including an incidence surface for receiving light irradiated from a back light source and an emission surface substantially perpendicular to the incidence surface for emitting the received light as a sheet light;
cleaning the light guide panel body;
forming a hard coating layer on the emission surface of the light guide panel; and
forming a polarizing coating layer having a refractive index of at least 2.0 on the hard coating layer, the polarizing coating layer being configured of one or more organic compound layers, and
wherein a difference between a transmittance of a P wave and a transmittance of an S wave of polarized light having passed through the polarizing coating layer from the light guide panel body is at least 50% in a visible light wavelength range.

23. The method of claim 22, wherein the cleaning step comprises:
disposing the light guide panel body into a container of liquid; and
vibrating the liquid at an ultrasonic frequency for about 1 minute.

24. The method of claim 22, wherein the step of forming a hard coating layer comprises:
applying a predetermined amount of coating solution onto the light guide panel body;
rotating the light guide panel body at a low speed to uniformly coat the hard coating solution on the light guide panel body; and
increasing a rotation speed of the light guide panel.

25. The method of claim 24, further comprising the step of, before the increasing step, determining if the solution is uniformly coated on the light guide panel body.
